(19) United States
(12) Patent Application Publication
(10) Pub. No.: US 2025/0387773 A1
(43) Pub. Date: Dec. 25, 2025

(54) PHOTOCATALYTIC CELL, HYDROGEN GAS GENERATION SYSTEM, AND PHOTOCATALYST SHEET

(71) Applicant: SHARP KABUSHIKI KAISHA, Sakai City (JP)

(72) Inventors: Hidetsugu KAWAI, Sakai City (JP); Takafumi NONAKA, Sakai City (JP)

(21) Appl. No.: 19/236,018

(22) Filed: Jun. 12, 2025

(30) Foreign Application Priority Data
Jun. 20, 2024 (JP) 2024-099725

(51) Int. Cl. B01J 19/12; B01J 15/00; B01J 23/30; B01J 35/39; B01J 35/40; B01J 35/58; C25B 1/04; C25B 1/50; C25B 15/08

(52) U.S. Cl. CPC B01J 19/122; B01J 15/005; B01J 23/30; B01J 35/39; B01J 35/40; B01J 35/58; C25B 1/04; C25B 1/50; C25B 15/08; B01J 2219/0886; B01J 2219/0892

(57) ABSTRACT

A photocatalytic cell of the disclosure is a photocatalytic cell that contains a photocatalyst sheet and an electrolyte. The photocatalyst sheet includes a carrier sheet provided with multiple fibers bonded thereto, and multiple photocatalyst particles supported or fixed on the carrier sheet, the multiple photocatalyst particles include tungsten oxide particles, and a mass of the multiple photocatalyst particles per unit area of the photocatalyst sheet is 20 g/m2 or more.

### INCORPORATION BY REFERENCE

This application claims priority under Section 119 of U.S.C. to Japanese Patent Application No. 2024-099725 filed on Jun. 20, 2024, the entire content of which is incorporated herein by reference.

### BACKGROUND

The disclosure relates to a photocatalytic cell, a hydrogen gas generation system, and a photocatalyst sheet.

### BACKGROUND ART

Since no CO₂ is emitted when hydrogen gas is used, hydrogen gas is expected to be a next generation energy source. In particular, “green hydrogen”, which is produced by electrolyzing water using electricity generated by solar or wind power, is attracting attention because no CO₂ is emitted during a production process of hydrogen. However, green hydrogen has a problem of high production cost. An electrolysis voltage of industrially used water electrolyzers is 1.5 to 2.1 V, which consumes a lot of power. A known device capable of generating hydrogen gas from water at a low electrolysis voltage is one that combines a photocatalyst that reduces iron ions in an electrolyte with an electrolytic cell that generates hydrogen gas (see, for example, JP 11-157801 A).

### SUMMARY

The disclosure provides a photocatalytic cell that contains a photocatalyst sheet and an electrolyte. The photocatalyst sheet includes a carrier sheet provided with multiple fibers bonded thereto, and multiple photocatalyst particles supported or fixed on the carrier sheet, the multiple photocatalyst particles include tungsten oxide particles, and a mass of the multiple photocatalyst particles per unit area of the photocatalyst sheet is 20 g/m² or more.

### ADVANTAGEOUS EFFECTS OF DISCLOSURE

In the photocatalyst sheet, the photocatalyst particles including the tungsten oxide particles are supported or fixed on the carrier sheet provided with the fibers. Therefore, the mass of the photocatalyst particles per unit area of the photocatalyst sheet can be made 20 g/m² or more, and light incident on the photocatalytic cell can be efficiently used for photocatalytic reaction. In addition, a mass per unit volume of the photocatalyst sheet can be increased, and the photocatalyst sheet can be submerged in the electrolyte. Thus, the photocatalyst sheet on which the photocatalyst particles are supported or fixed can be placed in the photocatalytic cell without moving, so that the electrolyte containing no photocatalyst particles can be easily taken out from the photocatalytic cell. In addition, floating, moving, bending, or the like of the photocatalyst sheet can be suppressed, and a reduction in a light-receiving area of the photocatalyst sheet in the photocatalytic cell can be suppressed.

### BRIEF DESCRIPTION OF THE DRAWINGS

FIG. 1 is a schematic cross-sectional view of a photocatalytic cell according to an embodiment of the disclosure.

FIG. 2 is a schematic cross-sectional view of a hydrogen gas generation system according to an embodiment of the disclosure.

### DETAILED DESCRIPTION OF THE INVENTION

A photocatalytic cell of the disclosure contains a photocatalyst sheet and an electrolyte. The photocatalyst sheet includes a carrier sheet provided with multiple fibers bonded thereto, and multiple photocatalyst particles supported or fixed on the carrier sheet. The multiple photocatalyst particles include tungsten oxide particles, and a mass of the multiple photocatalyst particles per unit area of the photocatalyst sheet is 20 g/m² or more.

A mean particle size D50 of the photocatalyst particles contained in the photocatalyst sheet is preferably 150 nm or more.

At least some of the multiple photocatalyst particles are preferably mixed in the carrier sheet provided with multiple fibrillated plant fibers.

At least some of the multiple photocatalyst particles are preferably mixed in the carrier sheet provided with multiple inorganic fibers.

A pH of the electrolyte is preferably less than 2.

Preferably, the electrolyte contains a first cation, and the electrolyte and the multiple photocatalyst particles are provided such that the first cation is reduced to a second cation by photocatalytic activity of the multiple photocatalyst particles generated by receiving light.

The photocatalytic cell preferably includes an inlet provided for supplying an electrolyte containing a first cation into the photocatalytic cell, and an outlet provided for discharging an electrolyte containing a second cation from the photocatalytic cell.

The disclosure also provides a hydrogen gas generation system including the photocatalytic cell of the disclosure and an electrolyzer including a cathode and an anode. The electrolyzer is configured to generate hydrogen gas from water or hydrogen ions at the cathode and to oxidize the second cation to the first cation at the anode. The photocatalytic cell and the electrolyzer are configured to supply an electrolyte containing the second cation generated in the photocatalytic cell to the electrolyzer, and to supply an electrolyte containing the first cation generated at the anode to the photocatalytic cell.

The disclosure also provides a photocatalyst sheet at least part of the photocatalyst sheet being placed in a liquid for use. The photocatalyst sheet includes a carrier sheet provided with multiple fibers bonded thereto, and multiple photocatalyst particles supported or fixed on the carrier sheet. The multiple photocatalyst particles include tungsten oxide particles. A mass of the multiple photocatalyst particles per unit area of the photocatalyst sheet is 20 g/m² or more.

An embodiment of the disclosure will be described below with reference to the drawings. Configurations illustrated in the drawings and the following description are examples, and the scope of the disclosure is not limited to the configurations illustrated in the drawings or the following description.

### Photocatalytic Cell

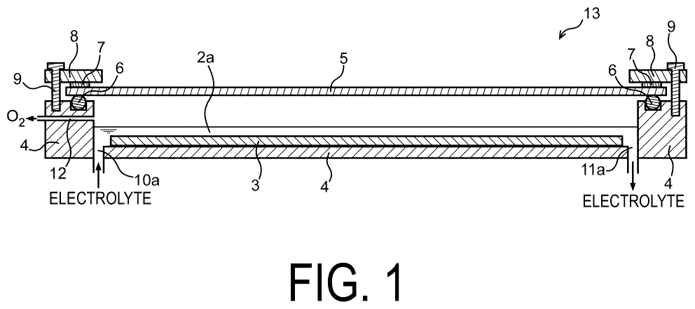

FIG. 1 is a schematic cross-sectional view of a photocatalytic cell of the present embodiment.

A photocatalytic cell 13 of the present embodiment contains a photocatalyst sheet 3 and an electrolyte 2a. The photocatalyst sheet 3 includes a carrier sheet provided with multiple fibers bonded thereto, and multiple photocatalyst particles supported or fixed on the carrier sheet. The multiple photocatalyst particles include tungsten oxide particles, and a mass of the multiple photocatalyst particles per unit area of the photocatalyst sheet 3 is 20 g/m² or more.

The photocatalytic cell 13 is a cell that contains the electrolyte 2a and the photocatalyst sheet 3. The photocatalytic cell 13 may be included in a cation reduction system that reduces a first cation contained in the electrolyte 2a to a second cation by photocatalytic activity. The photocatalytic cell 13 may also be included in a system that generates hydrogen gas or oxygen gas from the electrolyte 2a by photocatalytic activity.

The photocatalytic cell 13 may include a translucent member 5. This allows light transmitted through the translucent member 5 to be irradiated onto the photocatalyst particles contained in the photocatalyst sheet 3, allowing the photocatalyst particles to have photocatalytic activity.

The photocatalytic cell 13 includes, for example, a container 4 and the translucent member 5 that covers an opening of the container 4, as illustrated in FIG. 1. The translucent member 5 is fixed to the container 4 by a cover 8 and bolts 9. A cushioning material 7 is provided between the translucent member 5 and the cover 8, and a sealing member 6 is provided between the container 4 and the translucent member 5.

The photocatalytic cell 13 may have a flat shape, and the translucent member 5 that serves as a light-receiving surface may be placed on a wide surface having the flat shape.

The photocatalyst sheet 3 includes the carrier sheet and the multiple photocatalyst particles. The photocatalyst sheet 3 can be used in such a way that at least part of the photocatalyst sheet 3 is placed in a liquid.

The photocatalyst particles are particles that become photocatalytically active by receiving light, and are supported or fixed on the carrier sheet. The photocatalyst particles include tungsten oxide particles (WO₃ particles). Tungsten oxide has a wider light absorption band than titanium dioxide, and photocatalytic activity occurs even when tungsten oxide absorbs visible light that does not contain ultraviolet light. Therefore, photocatalytic activity can be caused even when light incident on the photocatalytic cell 13 passes through the electrolyte 2a and is then irradiated onto tungsten oxide particles (photocatalyst particles). Further, tungsten oxide has a higher specific gravity than titanium oxide. Therefore, a mass per unit area of the photocatalyst sheet 3 can be increased.

The tungsten oxide particles (WO₃ particles) included in the photocatalyst particles may be tungsten oxide particles having a composition deviating from a stoichiometric composition as long as the tungsten oxide particles have photocatalytic activity. The tungsten oxide particles may contain impurity atoms or additive atoms within a range in which photocatalytic activity is not lost. The photocatalyst particle may have a promoter on a surface thereof. Examples of promoters include platinum group metals such as Pt, Pd, Rh, Ru, Os, and Ir.

A mean particle size D50 of the photocatalyst particles (primary particles) contained in the photocatalyst sheet 3 is 150 nm or more, preferably 200 nm or more and 50 μm or less, and more preferably 500 nm or more and 30 μm or less.

The carrier sheet is a sheet provided with the multiple fibers bonded thereto. The carrier sheet is, for example, paper. The fibers are plant fibers, inorganic fibers, or the like. The plant fibers may be pulp fibers or cellulose. The plant fibers may be wood pulp fibers or wood cellulose, or non-wood pulp fibers or non-wood cellulose. The inorganic fibers may be glass fibers (e.g., SiO₂ fibers), ceramic fibers, or the like.

A carrier sheet containing plant fibers can be produced, for example, as follows. Pulp extracted from a plant or the like is dispersed in water and stirred to separate the pulp into individual plant fibers (disintegrated), and then the disintegrated plant fibers are subjected to mechanical shearing force to fluff the plant fibers (beating, fibrillation of the plant fibers). The beaten plant fibers are dispersed in water, and a dispersion is spread on a mesh to remove the water and form a sheet (sheet formation). The sheet after the sheet forming process is then pressed and dried to produce a carrier sheet.

Beating the plant fibers can soften the fibers and cause the fibers to fluff (fibrillate), thereby strengthening bonds between the fibers contained in the carrier sheet.

A carrier sheet containing inorganic fibers can be produced, for example, by spreading a dispersion of inorganic fibers in water onto a mesh, removing the water, forming a sheet (sheet formation), and pressing and drying the sheet after the sheet forming process. A binder can be added to the dispersion as needed.

The photocatalyst particles are supported or fixed on the carrier sheet. The photocatalyst particles may be supported or fixed on a surface of the carrier sheet, or may be supported or fixed inside the carrier sheet. The photocatalyst particles may be mixed in a carrier sheet provided with multiple fibrillated plant fibers (the photocatalyst particles are located between the multiple fibrillated plant fibers that are bonded to the carrier sheet). This allows a large number of photocatalyst particles to be supported or fixed on the carrier sheet. This also suppresses detachment of the photocatalyst particles from the photocatalyst sheet.

For example, a dispersion of the beaten plant fibers and the photocatalyst particles in water is spread on a mesh, the water is remove, and a sheet is formed (sheet formation), and the sheet after the sheet forming process is pressed and dried to produce the photocatalyst sheet 3 in which the photocatalyst particles are supported or fixed on the carrier sheet. The photocatalyst particles may be mixed in a carrier sheet provided with multiple inorganic fibers. For example, a dispersion of the inorganic fibers and the photocatalyst particles in water is spread on a mesh, the water is remove, and a sheet is formed (sheet formation), and the sheet after the sheet forming process is pressed and dried to produce the photocatalyst sheet 3 in which the photocatalyst particles are supported or fixed on the carrier sheet. A binder can be added to the dispersion as needed.

A mass of the photocatalyst particles per unit area of the photocatalyst sheet 3 is 20 g/m² or more, preferably 20 g/m² or more and 200 g/m² or less, and more preferably 30 g/m² or more and 150 g/m² or less. This allows light incident on the photocatalytic cell 13 to be efficiently used in photocatalytic reaction. Further, the mass per unit volume of the photocatalyst sheet 3 can be increased, allowing the photocatalyst sheet 3 to be submerged in the electrolyte 2a. Thus, the photocatalyst sheet 3 on which the photocatalyst particles are supported or fixed can be placed in the photocatalytic cell without moving, so that the electrolyte 2a containing no photocatalyst particles can be easily taken out from the photocatalytic cell 13. In addition, floating, moving, bending, or the like of the photocatalyst sheet 3 can be suppressed, and a reduction in a light-receiving area of the photocatalyst sheet 3 in the photocatalytic cell 13 can be suppressed.

In the photocatalytic cell 13, the photocatalyst sheet 3 and the photocatalyst particles are in contact with the electrolyte 2a. This allows a first cation contained in the electrolyte 2a to be reduced to a second cation by photocatalytic activity, or the photocatalytic cell 13 can generate hydrogen gas or oxygen gas from the electrolyte 2a by photocatalytic activity. For example, when the photocatalyst particle receives light, the first cation in the electrolyte 2a is reduced to the second cation, and oxygen gas is generated from the electrolyte 2a. This can be explained as follows. Light excites an electron in a valence band of the photocatalyst particle to a conduction band, forming a hole in the valence band. The electron in the conduction band moves to a surface of the photocatalyst particle, and the first cation to which the electron is added is reduced to the second cation (first reaction). Further, the hole in the valence band moves to the surface of the photocatalyst particle and react with H₂O to generate oxygen gas (second reaction). The generated oxygen gas moves into a gas phase in the photocatalytic cell 13 and is discharged to the outside of the photocatalytic cell 13 through an oxygen gas discharge hole 12.

For example, when the first cation is a trivalent iron ion (Fe³⁺) and the second cation is a divalent iron ion (Fe²⁺), the following reactions proceed.

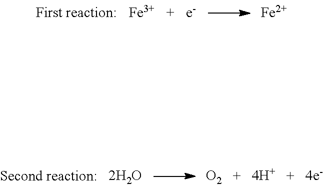

The generated hydrogen ions (H⁺) can be used in an electrolyzer 30 described later.

In the photocatalytic cell 13, the photocatalyst particles or the photocatalyst sheet 3 may be immersed in the electrolyte 2a. In the photocatalytic cell 13, the photocatalyst sheet 3 may be permeated with the electrolyte 2a. The photocatalyst sheet 3 may be placed at a bottom of the container 4.

The electrolyte 2a may be an aqueous solution containing a first cation. The first cation is reduced to a second cation by photocatalytic activity of the photocatalyst particle generated by receiving light.

When the electrolyte 2a contains iron sulfates (FeSO₄ and Fe₂(SO₄)₃), the first cation is a trivalent iron ion and the second cation is a divalent iron ion.

When the electrolyte 2a contains iron perchlorates (Fe(ClO₄)₃ and Fe (ClO₄)₂), the first cation is a trivalent iron ion and the second cation is a divalent iron ion.

The first and second cations may be metal complex ions. Metal contained in the metal complex ion is, for example, iron or cobalt.

A pH of the electrolyte 2a may be within a pH range in which a zeta potential of the photocatalyst particles is 0 V or higher. Electrostatic attraction force generated by this can increase a probability of contact between the photocatalyst particle and the first cation, thereby increasing a probability of reduction of the first cation to the second cation by photocatalytic activity. Thus, an electrolyte containing a larger amount of second cations can be produced. Further, by using this electrolyte to generate hydrogen gas in a hydrogen gas generation system described later, an efficiency of generating hydrogen gas can be improved.

When the photocatalyst particles include the tungsten oxide particles, a pH of the electrolyte 2a can be made smaller than 2 (to be on an acidic side). This allows the zeta potential of the photocatalyst particles to be made 0 V or higher, and also allows divalent iron ions and trivalent iron ions to exist stably in the electrolyte 2a. This suppresses oxidation of divalent iron ions to trivalent iron ions due to dissolved oxygen in the electrolyte 2a, oxygen gas in a gas phase, oxygen gas generated by photocatalytic activity, or the like.

For example, a pH of the electrolyte 2a may be adjusted by adjusting an iron sulfate concentration, an iron perchlorate concentration, or the like of the electrolyte 2a, or a pH of the electrolyte 2a may be adjusted by adding an acidic material such as sulfuric or perchloric acid to the electrolyte 2a.

When an electrolyte is prepared by dissolving about 50 g of iron perchlorate n-hydrate (manufactured by FUJIFILM Wako Pure Chemical Cooperation: n is about 8) in 10 L of water, the electrolyte has a pH of about 2.

The iron ion concentration of the electrolyte 2a is preferably, for example, 10 mmol/L to 1 mol/L. This is a concentration at which the iron ions can stably maintain respective valence states thereof. More preferably, the iron ion concentration of the electrolyte 2a is 10 mmol/L to 100 mmol/L. The lower the iron ion concentration, the smaller an effect coloring of the electrolyte caused by the iron ions, and the more decrease in an amount of light received by the photocatalyst can be suppressed.

The photocatalytic cell 13 can include an inlet 10a provided so as to supply the electrolyte 2a containing the first cation into the photocatalytic cell 13 and an outlet 11a provided so as to discharge the electrolyte 2a containing the second cation from the photocatalytic cell 13. The inlet 10a and the outlet 11a may be provided so that the electrolyte 2a flows through the photocatalytic cell 13. This allows the first cation contained in the electrolyte 2a injected into the photocatalytic cell 13 from the inlet 10a to come into contact with the photocatalyst particle, and the first cation can be reduced by photocatalytic activity and converted into the second cation. Further, the electrolyte 2a containing the second cation generated by photocatalytic activity can be taken out from the photocatalytic cell 13, and the electrolyte 2a containing the second cation can be used.

### Hydrogen Gas Generation System

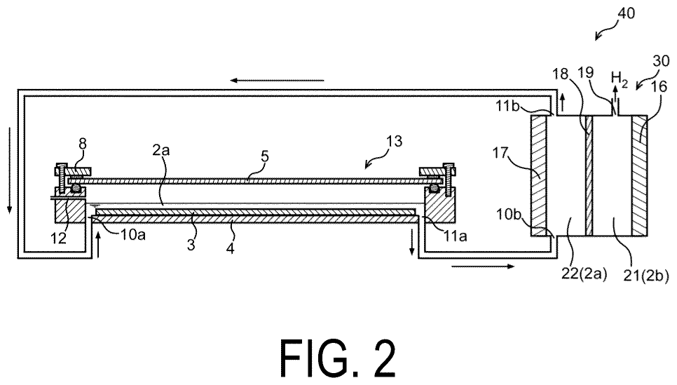

FIG. 2 is a schematic cross-sectional view of a hydrogen gas generation system of the present embodiment.

A hydrogen gas generation system 40 of the present embodiment includes a photocatalytic cell 13 and an electrolyzer 30 including a cathode 16 and an anode 17. The electrolyzer 30 is configured to generate hydrogen gas from water or hydrogen ions at the cathode 16 and to oxidize a second cation to a first cation at the anode 17. The photocatalytic cell 13 and the electrolyzer 30 are configured to supply an electrolyte 2a containing the second cation generated by the photocatalytic cell 13 to the electrolyzer 30, and are configured to supply the electrolyte 2a containing the first cation generated at the anode 17 to the photocatalytic cell 13.

The electrolyzer 30 may include a power supply unit provided to apply a voltage between the anode 17 and the cathode 16. The electrolyzer 30 may include an anode chamber 22 and a cathode chamber 21 separated by an ion exchange membrane 18.

The electrolyte 2a containing the second cations generated by the photocatalytic cell 13 is supplied to the electrolyzer 30 to fill the anode chamber 22 with the electrolyte 2a and the cathode chamber 21 with an electrolyte 2b. Then, when a voltage is applied between the anode 17 and the cathode 16 using the power supply unit, anodic reaction proceeds on a surface of the anode 17, and cathodic reaction proceeds on a surface of the cathode 16. With the anodic reaction and the cathodic reaction, hydrogen ions (H+) contained in the electrolyte 2a in the anode chamber 22 move to the electrolyte 2b in the cathode chamber 21 through the ion exchange membrane 18. The electrolyte 2b can be an acidic electrolyte.

In the anode 17, a reaction proceeds in which the second cations contained in the electrolyte 2a in the anode chamber 22 transfer electrons to the anode 17 and are oxidized to the first cations (anodic reaction).

For example, when the first cation is a trivalent iron ion (Fe³⁺) and the second cation is a divalent iron ion (Fe²⁺), the following anodic reaction proceeds.

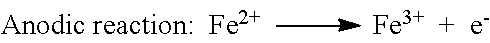

The anode chamber 22 may include an inlet 10b provided to supply the electrolyte 2a containing the second cations generated in the photocatalytic cell 13 into the anode chamber 22 and an outlet 11b provided to discharge the electrolyte 2a containing the first cations generated from the second cations at the anodic 17 from the anode chamber 22. The inlet 10b and the outlet 11b may be provided so that the electrolyte 2a injected from the inlet 10b passes through the anode chamber 22 and then is discharged from the outlet 11b. By circulating the electrolyte 2a in this way, the anodic reaction can proceed continuously and stably.

The electrolyte 2a containing the second cations generated in the photocatalytic cell 13 may be supplied to the anode chamber 22 of the electrolyzer 30 through a liquid feed pipe or a pump. The electrolyte 2a containing the second cations generated in the photocatalytic cell 13 may be stored in a storage tank. The electrolyte 2a may then be transported in a state of being stored in the storage tank, and the electrolyte 2a stored in the storage tank may be supplied to the anode chamber 22 of the electrolyzer 30 at a destination.

The electrolyte 2a containing the first cations discharged from the anode chamber 22 of the electrolyzer 30 may be supplied to the photocatalytic cell 13 through a liquid feed pipe or a pump. The electrolyte 2a containing the first cations discharged from the anode chamber 22 of the electrolyzer 30 may be stored in a storage tank. The electrolyte 2a may then be transported in a state of being stored in the storage tank, and the electrolyte 2a stored in the storage tank may be supplied to the photocatalytic cell 13 at a destination. In such a system in which the electrolyte 2a is circulated, water may be added to the circulating electrolyte 2a. This allows the water consumed in the second reaction described above to be replenished.

At the cathode 16, the following cathodic reaction proceeds in which hydrogen ions contained in the electrolyte 2b in the cathode chamber 21 receive electrons to generate hydrogen gas.

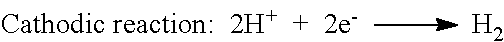

The generated hydrogen gas is discharged to the outside of the cathode chamber 21 through a hydrogen gas discharge hole 19 and stored in a hydrogen storage tank.

The anodic reaction and the cathodic reaction described above proceed at a lower applied voltage (a voltage applied between the cathode 16 and the anode 17 by the power supply unit) than in known water electrolysis systems. Therefore, the cost of producing hydrogen gas can be reduced.

### DESCRIPTION OF SYMBOLS

2a, 2b: Electrolyte
3: Photocatalyst sheet
4: Container
5: Translucent member
6: Sealing member
7: Cushioning material
8: Cover
9: Bolt
10a, 10b: Inlet
11a, 11b: Outlet
12: Oxygen gas discharge hole
13: Photocatalytic cell
16: Cathode
17: Anode
18: Ion exchange membrane
19: Hydrogen gas discharge hole
21: Cathode chamber
22: Anode chamber
30: Electrolyzer
40: Hydrogen gas generation system

1. A photocatalytic cell containing a photocatalyst sheet and an electrolyte,
wherein the photocatalyst sheet including a carrier sheet provided with multiple fibers bonded to the carrier sheet, and multiple photocatalyst particles supported or fixed on the carrier sheet,
the multiple photocatalyst particles include tungsten oxide particles, and
a mass of the multiple photocatalyst particles per unit area of the photocatalyst sheet is 20 g/m² or more.

2. The photocatalytic cell according to claim 1,
wherein a mean particle size D50 of the multiple photocatalyst particles contained in the photocatalyst sheet is 150 nm or more.

3. The photocatalytic cell according to claim 1,
wherein at least some of the multiple photocatalyst particles are mixed in the carrier sheet provided with multiple fibrillated plant fibers.

4. The photocatalytic cell according to claim 1,
wherein at least some of the multiple photocatalyst particles are mixed in the carrier sheet provided with multiple inorganic fibers.

5. The photocatalytic cell according to claim 1,
wherein the electrolyte has a pH of less than 2.

6. The photocatalytic cell according to claim 1,
wherein the electrolyte contains a first cation, and
the electrolyte and the multiple photocatalyst particles reduce a first cation to a second cation by photocatalytic activity of the multiple photocatalyst particles generated by receiving light.

7. The photocatalytic cell according to claim 6, further comprising:
an inlet that supplies an electrolyte containing a first cation into the photocatalytic cell; and
an outlet that discharges an electrolyte containing a second cation from the photocatalytic cell.

8. A hydrogen gas generation system comprising:
the photocatalytic cell according to claim 6; and
an electrolyzer including a cathode and an anode, the electrolyzer generating hydrogen gas from water or hydrogen ions at the cathode, and oxidizing a second cation to a first cation at the anode,
wherein the photocatalytic cell and the electrolyzer supply an electrolyte containing the second cation generated in the photocatalytic cell to the electrolyzer, and supply an electrolyte containing the first cation generated at the anode to the photocatalytic cell.

9. A photocatalyst sheet at least part of the photocatalyst sheet being placed in a liquid for use, the photocatalyst sheet comprising:
a carrier sheet provided with multiple fibers bonded to the carrier sheet; and
multiple photocatalyst particles supported or fixed on the carrier sheet,
wherein the multiple photocatalyst particles include tungsten oxide particles, and
a mass of the multiple photocatalyst particles per unit area of the photocatalyst sheet is 20 g/m² or more.
